(19) United States
(12) Patent Application Publication
(10) Pub. No.: US 2007/0271011 A1
(43) Pub. Date: Nov. 22, 2007

(54) Indoor map building apparatus, method, and medium for mobile robot

(75) Inventors: Hyoung-ki Lee, Yongin-si (KR); Dong-yoon Kim, yongin-si (KR); Seok-won Bang, Yongin-si (KR); Hyeon Myeong, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-Si (KR)

(21) Appl. No.: 11/715,977

(22) Filed: Mar. 9, 2007

(30) Foreign Application Priority Data
May 12, 2006 (KR) 10-2006-0043127
May 26, 2006 (KR) 10-2006-0047756

(51) Int. Cl. G06F 19/00; G05D 1/02

(52) U.S. Cl. 701/25; 901/1

(57) ABSTRACT

An indoor map building apparatus, method, and medium for a mobile robot are provided. The indoor map building apparatus includes a beacon which transmits/receives signals for determining the location of the mobile robot, a beacon location fixing module which moves the beacon to a predetermined location in an indoor space where the mobile robot is to travel and fixes the beacon at the predetermined location, a data processing module which determines the location of the mobile robot based on signals received from the beacon, and generates map information regarding the indoor space, an obstacle detection module which detects an obstacle when the mobile robot travels in the indoor space, and a driving module which moves the mobile robot.

### CROSS-REFERENCE TO RELATED APPLICATIONS

This application claims the benefit of Korean Patent Application No. 10-2006-0043127 and 10-2006-0047756 filed on May 12, 2006 and May 26, 2006, in the Korean Intellectual Property Office, the disclosures of which is incorporated herein by reference in its entirety.

### BACKGROUND OF THE INVENTION

1. Field of the Invention

The present invention relates to navigating a mobile robot, and more particularly, to an indoor map building apparatus and a method and medium for a mobile robot that involves the use of a mobile beacon.

2. Description of the Related Art

Robots were originally developed for industrial purposes and have been widely used for realizing factory automation and performing various functions in hazardous or extreme environments on behalf of humans. Nowadays, robotics has evolved from the field of state-of-the-art space robots to the field of human-friendly home robots. Also, robots can replace conventional medical equipment by being injected into the human body and repairing tissues that might not have been cured otherwise. With recent achievements in the robotics field, robotics has moved into the limelight of the world in anticipation that robotics, as one of the most advanced fields of science, will increasingly replace other fields of science such as Internet-based information technology and biotechnology.

In particular, home robots have expanded the scope of the existing robotics field that focuses more on heavy industrial applications to cover light industrial applications. Typical examples of such home robots include cleaning robots. Cleaning robots generally include a driving unit for driving them to move, a cleaning unit for performing a cleaning function, and an obstacle detection unit for sensing obstacles.

Referring to FIG. 1A, a conventional cleaning robot 1 travels in a limited area 2. When an obstacle appears in front of the conventional cleaning robot 1, the conventional cleaning robot 1 detects the obstacle with the aid of an obstacle detection unit and changes its direction of movement to avoid the obstacle. Since the conventional cleaning robot 1 detects obstacles and moves according to the results of the detection, the operation of the conventional cleaning robot 1 is performed randomly. Thus, the conventional cleaning robot 1 may clean the same spots more than one time or leave spots uncleaned during a cleaning operation. Also, the conventional cleaning robot 1 may keep traveling in the same areas or may not be able to move directly to the nearest uncleaned spots, thereby deteriorating the operating efficiency of the conventional cleaning robot 1.

Referring to FIG. 1B, a conventional cleaning robot 3 determines its location with the aid of a predetermined unit, figures out an area 2 to be cleaned, and moves along an optimum path, thereby reducing the time taken to clean up the area 2 and the power consumption of the conventional cleaning robot 3.

Mobile robots such as cleaning robots that are supposed to perform functions while navigating within a limited area are generally required to perform localization, which is a process of determining the location of a mobile robot, and map building, which is a process of building a map of an area where a mobile robot is to navigate.

Korean Patent Laid-Open Gazette No. 2002-033303 discloses a technique of determining the location of a mobile robot using the operating principles of a global position system (GPS), the technique involving installing three or more beacons on the walls of a room where the mobile robot is to travel. In addition, Korean patent Laid-Open Gazette No. 2005-0063538 discloses a technique of determining the location of a mobile robot which involves attaching a plurality of ultrasound generators to a charging stand; calculating the time taken for an ultrasound signal transmitted by the charging stand to arrive at a mobile robot based on a radio frequency (RF) signal transmitted at regular intervals of time by the mobile robot; and determining the distance between the charging stand and the mobile robot and the angle between the charging stand and the mobile robot.

The aforementioned techniques, however, do not suggest ways to precisely measure the shortest distance between two points (e.g., between a beacon or a charging stand that is fixed at a predetermined location and a mobile robot that moves about the beacon or the charging stand) that are on the opposite sides of a wall and are thus blocked by the wall. Thus, in order to determine the location of a mobile robot or generate map information using the aforementioned techniques, beacons must be installed in each room, or a charging stand must be moved whenever necessary.

### SUMMARY OF THE INVENTION

Additional aspects, features, and/or advantages of the invention will be set forth in part in the description which follows and, in part, will be apparent from the description, or may be learned by practice of the invention.

The present invention provides an indoor map building apparatus and a method and medium for a mobile robot which can set an area of movement of a mobile robot and build a map of an entire indoor space where the mobile robot is to travel by moving a beacon that transmits/receives signals for determining the location of the mobile robot from one place to another in the indoor space without the need to install additional beacons and charging stands.

The present invention also provides an apparatus, method, and medium to prevent a mobile robot from leaving spots uncleaned or cleaning the same spots more than one time while performing a cleaning operation by using the indoor map building apparatus, method, and medium of a mobile robot.

According to an aspect of the present invention, there is provided an indoor map building apparatus of a mobile robot. The indoor map building apparatus includes a beacon which transmits/receives signals for determining the location of the mobile robot, a beacon location fixing module which moves the beacon to a predetermined location in an indoor space where the mobile robot is to travel and fixes the beacon at the predetermined location, a data processing module which determines the location of the mobile robot based on signals received from the beacon, and generates map information regarding the indoor space, an obstacle detection module which detects an obstacle when the mobile robot travels in the indoor space, and a driving module which moves the mobile robot.

According to another aspect of the present invention, there is provided an indoor map building method for a mobile robot. The indoor map building method includes (a) moving a beacon that transmits/receives signals for determining the location of the mobile robot to a predetermined location in an indoor space where the mobile robot is to travel, (b) determining the location of the mobile robot based on signals received from the beacon, and generating outline information regarding the indoor space, and (c) determining whether the outline information corresponds to a closed curve and, if it is determined that the outline information does not correspond to a closed curve, enabling the mobile robot to place the beacon to an open space that is nearest to the mobile robot.

According to another aspect of the present invention, there is provided an indoor map building apparatus of a mobile robot, the apparatus including a beacon which transmits/receives signals for determining the location of the mobile robot; a beacon location fixing module which moves the beacon to a predetermined location in an indoor space where the mobile robot is to travel and fixes the beacon at the predetermined location; and a data processing module which determines the location of the mobile robot based on signals received from the beacon, and generates map information regarding the indoor space.

According to another aspect of the present invention, there is provided an indoor map building method for building a map of an indoor space using a mobile robot, the method including (a) determining the location of the mobile robot based on signals received from the beacon, and generating outline information of the indoor space; and (b) determining whether the outline information corresponds to a closed curve and, if it is determined that the outline information does not correspond to a closed curve, enabling the mobile robot to move the beacon to an open space that is nearest to the mobile robot and place the beacon in the open space

According to another aspect of the present invention, there is provided at least one computer readable medium storing computer readable instructions to implement methods of the present invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. These and/or other aspects, features, and advantages of the invention will become apparent and more readily appreciated from the following description of exemplary embodiments, taken in conjunction with the accompanying drawings of which:

FIG. 1A is a diagram for illustrating a path of movement of a conventional mobile robot;

FIG. 1B is a diagram for illustrating a path of movement of another conventional mobile robot;

FIG. 2A is a diagram for illustrating a mobile robot and a beacon according to an exemplary embodiment of the present invention;

FIG. 2B is a diagram for illustrating a (x, y, y) coordinate system that defines the relationships between the location of a mobile robot and the location of a beacon and between the direction of the mobile robot and the direction of the beacon according to an exemplary embodiment of the present invention;

FIG. 3 is a block diagram of an indoor map building apparatus of a mobile robot according to an exemplary embodiment of the present invention;

FIG. 4 is a detailed block diagram of a data processing module illustrated in FIG. 3;

FIG. 5 is a diagram for explaining the calculation of the distance between a mobile robot and a beacon by transmitting an ultra wide band (UWB) signal between the mobile robot and the beacon, according to an exemplary embodiment of the present invention;

FIG. 6 is a diagram for illustrating an indoor map built by a mobile robot according to an exemplary embodiment of the present invention;

FIG. 7 is a block diagram of an indoor map building apparatus of a mobile robot according to another exemplary embodiment of the present invention;

FIG. 8 is a block diagram of an indoor map building apparatus of a mobile robot according to another exemplary embodiment of the present invention;

FIG. 9 is a flowchart illustrating an indoor map building method of a mobile robot according to an exemplary embodiment of the present invention;

FIG. 10 is a flowchart illustrating operation S1210 of FIG. 9;

FIG. 11 is a flowchart illustrating a method of attaching a beacon to a mobile robot according to an exemplary embodiment of the present invention;

FIG. 12 is a flowchart illustrating an indoor map building method of a mobile robot when the location of a beacon is changed according to another exemplary embodiment of the present invention; and

FIGS. 13A and 13B are diagrams for comparing an area of movement of a mobile robot that is set using an indoor map building method of a mobile robot according to an exemplary embodiment of the present invention with an area of movement of a mobile robot that is set using a conventional indoor map building method of a mobile robot.

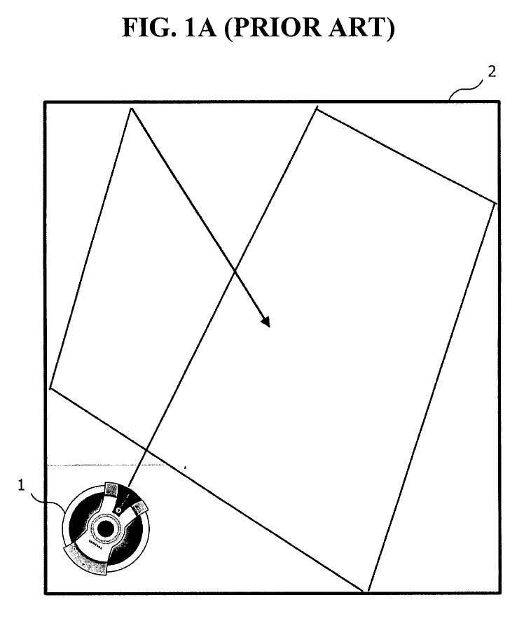

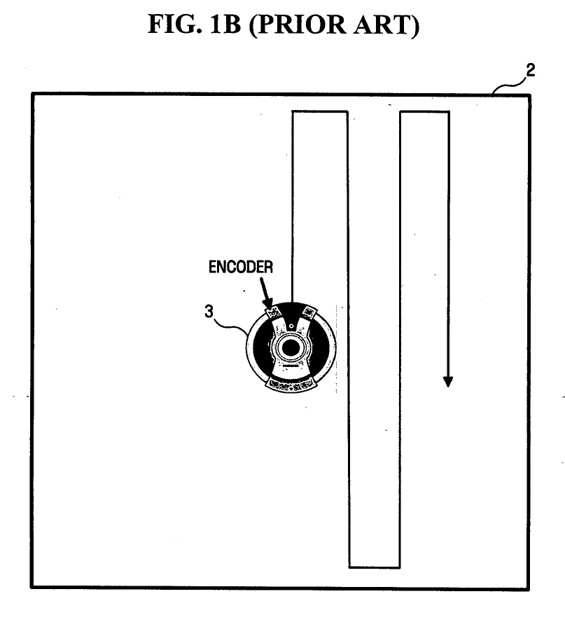

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

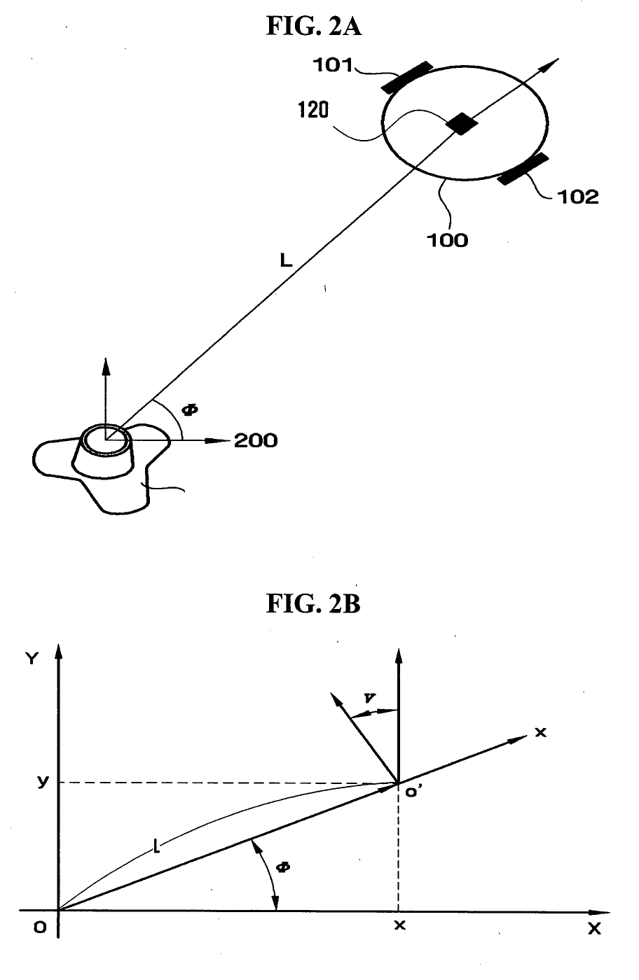

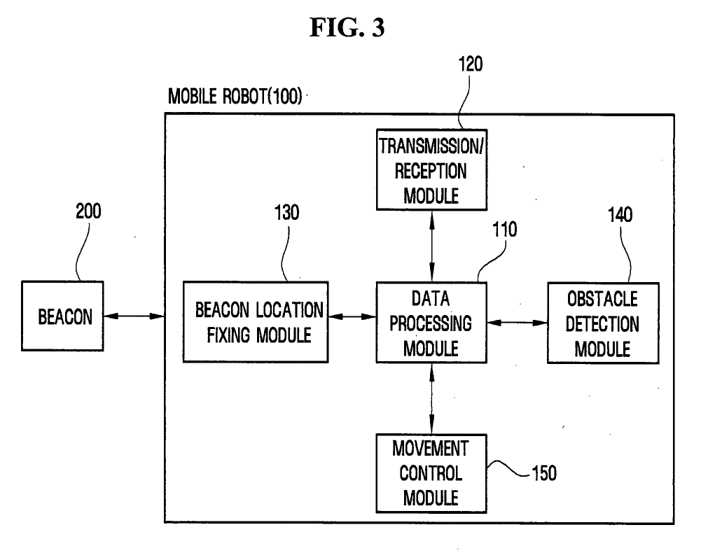

FIG. 2A is a diagram for illustrating a mobile robot 100 and a beacon 200 according to an exemplary embodiment of the present invention. Referring to FIG. 2A, the mobile robot 100 includes navigation wheels 101 and 102 which enable the mobile robot 100 to navigate, and a transmission/reception module 120 which is installed at the center of the mobile robot 100. The beacon 200 includes a transmission/reception module (not shown). The beacon 200 is located a predetermined distance apart from the transmission/reception module 120. The transmission/reception module 120 of the mobile robot 100 transmits/receives signals to/from the beacon 200. The mobile robot 100 and the beacon 200 can determine the location (L, φ) of the mobile robot 100 relative to the origin of coordinate axes of the beacon 200.

FIG. 2B is a diagram for illustrating a (x, y, v) coordinate system that defines the relationships between the location of the mobile robot 100 and the location of the beacon 200 and between the direction of the mobile robot 100 and the direction of the beacon 200. Referring to FIG. 2B, a coordinate pair (x, y) corresponds to a plane position O′ of the mobile robot relative to the origin 0, and y indicates a direction toward which the mobile robot 100 currently faces. The coordinate pair (x, y) may be replaced by a polar coordinate pair (L, φ). Here, the polar coordinate L can be determined by calculating a delay in the transmission of a ultra wide band (UWB) signal between the mobile robot 100 and the beacon 200, and the polar coordinate φ can be determined based on a signal into which angular information that specifies the angle between a light receiver (not shown) of the mobile robot 100 and a light emitting diode (LED) (not shown) of the beacon 200 is coded or can be estimated using a Kalman filter. However, the present invention is not restricted to this.

FIG. 3 is a block diagram of an indoor map building apparatus of a mobile robot 100 according to an exemplary embodiment of the present invention. Referring to FIG. 3, the indoor map building apparatus includes a beacon 200 and the mobile robot 100. The mobile robot 100 includes a data processing module 110, a transmission/reception module 120, a beacon location fixing module 130, an obstacle detection module 140, and a movement control module 150.

The structure of the indoor map building apparatus of the mobile robot 100 will hereinafter be described in further detail.

The beacon 200 is initially fixed at a certain location in an indoor space where the mobile robot 100 is to travel, and transmits/receives signals to/from the mobile robot 100 in order to determine the location of the mobile robot 100 relative to the beacon 200. One of the features of the present invention which differentiates the present invention from the prior art is that the present invention enables the beacon 200 to move like the mobile robot 100.

The transmission/reception module 120 transmits/receives signals to/from the beacon 200 that is detached from the mobile robot 100 in order to determine the location of the mobile robot 100 relative to the beacon 200, and provides signals received from the beacon 200 to the data processing module 110. The data processing module 110 determines the distance between the beacon 200 to the mobile robot 100 on a 2D plane whose origin is the location of the beacon 200 based on the signals provided by the transmission/reception module 120 and timing information of the corresponding signals.

Examples of the signals provided by the transmission/reception module 120 include UWB signals, infrared (IR) signals, and radio frequency (RF) signals, but the present invention is not restricted thereto. According to the present exemplary embodiment, assume that the mobile robot 100 uses UWB signals to determine the location of the mobile robot 100 relative to the beacon 200.

The beacon location fixing module 130 includes a beacon loading unit (beacon loader) (not shown) which enables the mobile robot 100 to load the beacon 200 and thus move along with the beacon 200. Also, the beacon location fixing module 130 moves the beacon 200 under the control of the data processing module 110 to a predetermined location in the indoor space. The beacon loading unit may be an electromagnetic unit such as an electromagnet or a mechanical unit that is formed in a rugged shape and can thus engage the beacon 200, but the present invention is not restricted thereto.

The data processing module 110 determines the distance between the mobile robot 100 and the beacon 200 based on the signals provided by the transmission/reception module 120, thereby determining the location and azimuth of the mobile robot 100. Also, the data processing module 110 generates map information regarding the indoor space by sensing walls in the indoor space with the aid of the obstacle detection module 140.

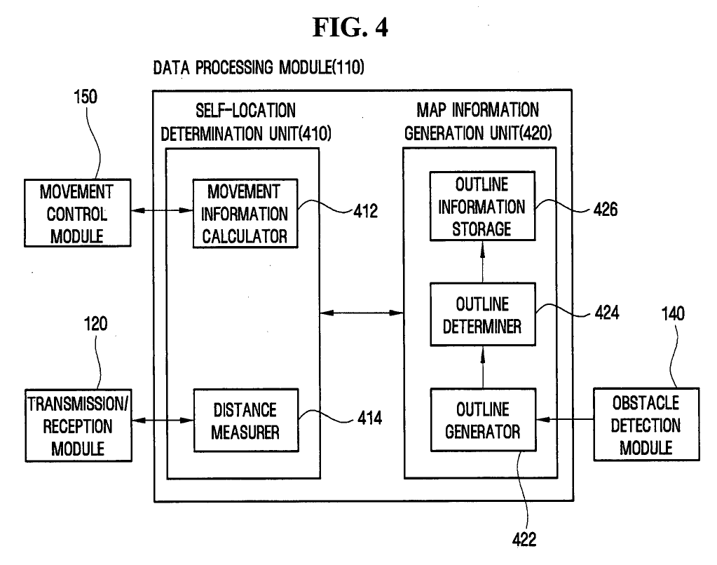

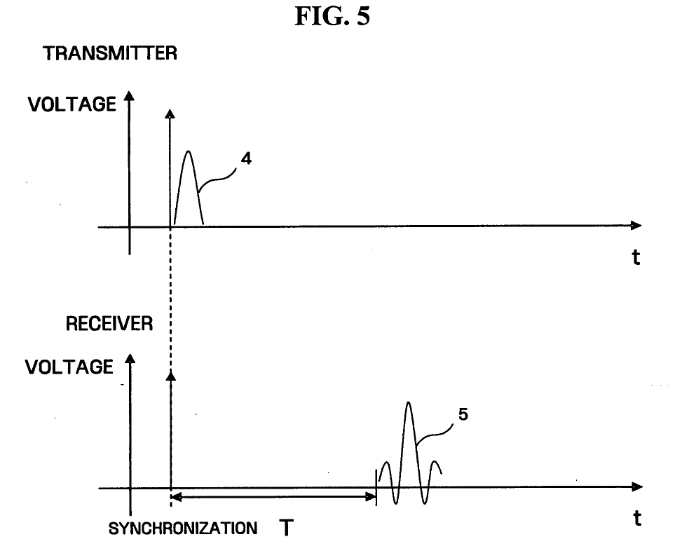

FIG. 4 is a detailed block diagram of the data processing module 110 illustrated in FIG. 3. Referring to FIG. 4, the data processing module 110 includes a self-location determination unit (self-location determiner) 410 which determines the location of the mobile robot 100, and a map information generation unit (map information generator) 420 which generates map information regarding an indoor space where the mobile robot 100 is to travel. The determination of the location of the mobile robot 100 by the self-location determination unit 410 will hereinafter be described in further detail with reference to FIG. 5, which is a diagram for explaining the transmission of a UWB signal between the mobile robot 100 and the beacon 200.

Referring to FIG. 5, a transmitter transmits a UWB pulse 4 having a predetermined amplitude (i.e., voltage) to a receiver. If the transmitter is the beacon 200, then the receiver may be the mobile robot 100. If the transmitter is the mobile robot 100, then the receiver may be the beacon 200. A predetermined amount of time T after the transmission of the UWB pulse 4, the receiver receives a slightly distorted signal 5. Here, the transmitter and the receiver both include a timer, and the timer of the transmitter is synchronized with the timer of the receiver. If the receiver receives a UWB signal the predetermined amount of time T after the transmission of the UWB signal by the transmitter, the distance between the receiver and the transmitter can be determined by multiplying the predetermined amount of time T by the speed of radio waves (I.e., 300,000 km/sec).

Referring to FIG. 4, a movement information calculator 412 detects the rotation speed of navigation wheels included in the movement control module 150, and performs dead reckoning, which is a process of estimating the displacement between a previous location of the mobile robot 100 and a current location of the mobile robot 100 and displacement in the direction of the mobile robot 100, according to the result of the detection. The movement information calculator 412 generally uses an encoder (not shown) to perform dead reckoning. The encoder is generally used for issuing a command to move the mobile robot 100 or to change the direction of the mobile robot 100 and controlling the movement of the mobile robot 100 in response to the command. The mobile robot 100 can determine its location by integrating movement and direction information of the mobile robot 100 using the encoder. If no integration error exists, the mobile robot 100 may be able to precisely determine its location simply using the encoder. However, errors are likely to accumulate whenever sampling is performed using, for example, an odometer. Thus, the movement information calculator 412 may use a gyroscope as well as the encoder. A gyroscope can improve the performance of azimuth measurement by measuring the angular velocity of an object that turns round.

The self-location determination unit 410 determines the location and azimuth of the mobile robot 100 based on location information provided by a distance measurer 414 and location and azimuth information provided by the movement information calculator 412. In other words, the self-location determination unit 410 determines the location and direction of the mobile robot 100 by estimating an optimum location and an optimum azimuth of the mobile robot 100 using a Kalman filter based on absolute location information of the mobile robot 100 provided by the distance measurer 414 and movement information of the mobile robot 100 provided by the encoder of the movement information calculator 412, wherein the absolute location information indicates the location of the mobile robot 100 relative to the beacon 200. The estimation of the optimum location of the mobile robot 100 by using a Kalman filter is well known to one of ordinary skill in the art to which the present invention pertains, and thus, a detailed description thereof will be skipped.

The operation of the map information generation unit 420, i.e., the generation of map information regarding the indoor space, will hereinafter be described in detail.

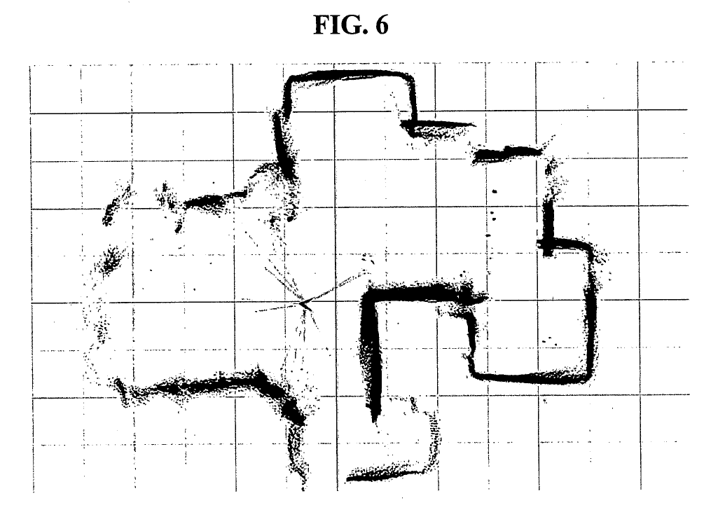

The map information generation unit 420 generates map information regarding the space based on the results of the determination performed by the self-location determination unit 410. The obstacle detection module 140 provides an outline generator 422 with wall detection information that is obtained by detecting walls in the indoor space and moving along the detected walls. Then, the outline generator 422 generates outline information regarding the indoor space based on the wall detection information, and this will hereinafter be described in further detail with reference to FIG. 6.

FIG. 6 is a diagram illustrating an indoor map built by the mobile robot 100 according to an exemplary embodiment of the present invention. According to the present exemplary embodiment, an indoor map is built based on current location information of the mobile robot 100 determined by the self-location determination unit 410 and outline information obtained by the obstacle detection module 140 while the obstacle detection module 140 moves along the walls in the indoor space. The obstacle detection module 140 may be a range-finder sensor, but the present invention is not restricted to this.

The indoor map illustrated in FIG. 6 may be built using a grid map method. According to the grid map method, areas where walls or obstacles exist are represented by black blocks, areas where no walls or no obstacles exist are represented by white blocks, and areas that have not yet been explored are represented by gray blocks. Referring to FIG. 6, black outlines constituted by black blocks may correspond to walls or obstacles, and a white area enclosed by the black outlines may correspond to, for example, the floor of an empty living room where no obstacles exist. The mobile robot 100 may set an area of movement of the mobile robot 100, and reference an indoor map built in the aforementioned manner to decide how to efficiently travel in the indoor space according to the result of the setting.

Referring to FIG. 4, a closed curve determiner 424 determines whether outline information provided by the outline generator 422 corresponds to a closed curve. If the outline information provided by the outline generator 422 does not correspond to a closed curve, then the mobile control module 150 may control the mobile robot 100 to move to a current location of the beacon 200, and then, a beacon attachment/detachment unit (not shown) of the beacon location fixing module 130 attaches the beacon 200 to the mobile robot 100. Thereafter, the mobile control module 150 may control the mobile robot 100 to move to the nearest open space. Here, the mobile robot 100 may use the encoder or a Simultaneous Localization and Map Building (SLAM) method involving the use of a previously built grid map to move to the nearest open space, but the present invention is not restricted thereto. Once the mobile robot 100 moves to the nearest open space, the beacon location fixing module 130 moves the beacon 200 to a predetermined location. Then, the mobile robot 100 determines the location of the mobile robot 100 to the beacon 200 again, and generates new map information based on the result of the determination.

If the outline information provided by the outline generator 422 corresponds to a closed curve, a map information storage 426 stores the corresponding outline information, i.e., closed curve information, as map information regarding the indoor space, thereby finalizing the setting of an area of movement of the mobile robot 100. Accordingly, it is possible for the mobile robot 100 to efficiently navigate and perform its operations with reference to previously built map information stored in the map information storage 426.

The obstacle detection module 140 enables the mobile robot 100 to detect the walls in the region where the mobile robot 100 is to travel and enables the mobile robot 100 to move along the detected walls, when the mobile robot 100 travels around the beacon 200 in the indoor space in order to determine the location of the mobile robot 100 and generate map information.

The movement control module 150 supplies power to the mobile robot 100 so that the mobile robot 100 can move. In detail, the movement control module 150 controls the mobile robot 100 to travel around the beacon 200 and thus to determine the location of the mobile robot 100 and generate map information. Also, the movement control module 150 controls the mobile robot 100 to properly travel along with the beacon 200 in the indoor space when the beacon 200 is attached to the mobile robot 100. The movement control module 150 may include a plurality of wheels and a direction control device. However, the movement control module 150 may include means of transportation for the mobile robot 100, other than the wheels and the direction control device.

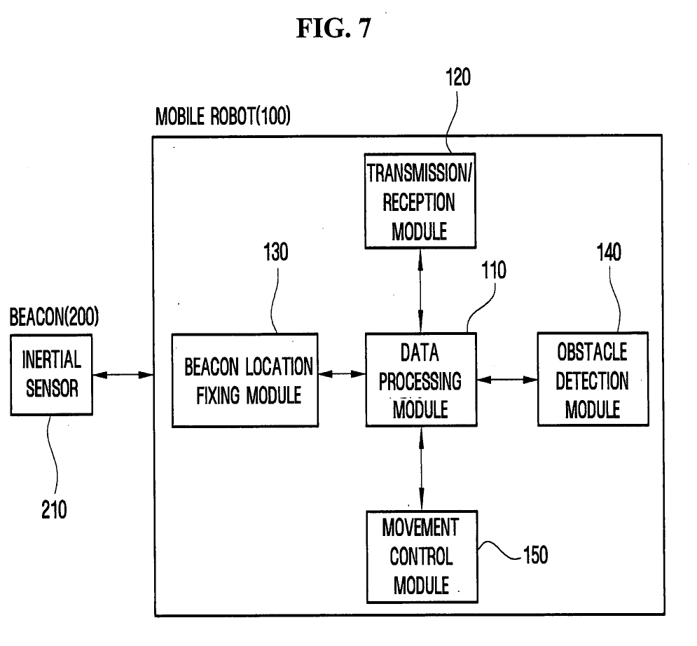

FIG. 7 is a block diagram of an indoor map building apparatus of a mobile robot 100 according to another exemplary embodiment of the present invention when the location of a beacon 200 is changed during the navigation of the mobile robot 100. Referring to FIG. 7, the indoor map building apparatus includes the beacon 200 which comprises an inertial sensor 210, a data processing module 110, a transmission/reception module 120, a beacon location fixing module 130, an obstacle detection module 140, and a movement control module 150.

The inertial sensor 210 of the beacon 200 periodically measures an inertial sensor value, and outputs the results of the measurement to the data processing module 110. The data processing module 110 determines whether an inertial sensor value (hereinafter referred to as the first inertial sensor value) output by the inertial sensor 210 is higher than a predefined threshold. If the first inertial sensor value is higher than the predefined threshold, the data processing module 110 determines that the location of the beacon 200 has been changed, and controls the movement control module 150 to stop the mobile robot 100 from moving. A predetermined amount of time later, the inertial sensor 210 measures another inertial sensor value (hereinafter referred to as the second inertial sensor value). If the second inertial sensor value is lower than the predefined threshold, the location of the mobile robot 100 relative to the beacon 200 is reset, and new map information regarding the indoor space is generated.

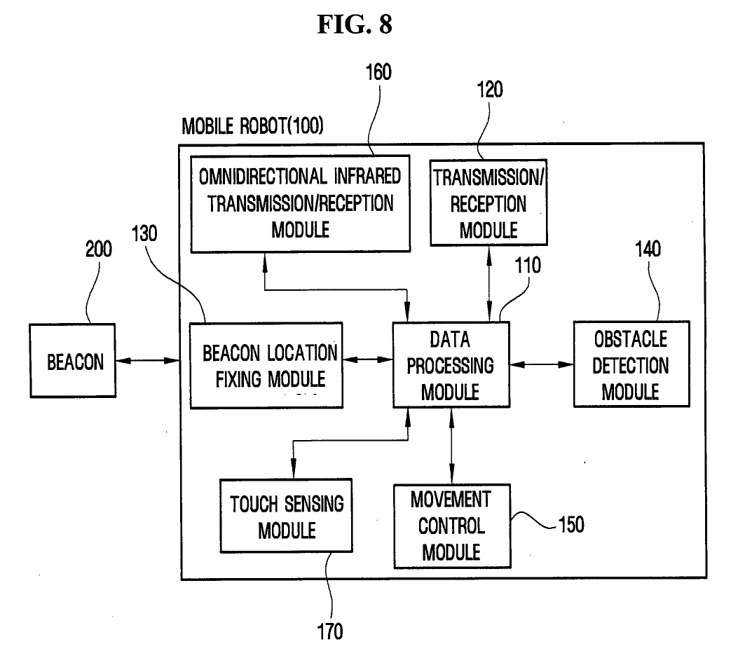

FIG. 8 is a block diagram of an indoor map building apparatus of a mobile robot 100 according to another exemplary embodiment of the present invention. Referring to FIG. 8, the indoor map building apparatus includes a beacon 200, a data processing module 110, a transmission/reception module 120, a beacon location fixing module 130, an obstacle detection module 140, a movement control module 150, an omnidirectional infrared transmission/reception module 160, and a touch sensing module 170.

The omnidirectional infrared transmission/reception module 160 measures the angle between the beacon location fixing module 130 of the mobile robot 100 and the beacon 200 on a two-dimensional coordinate plane whose origin corresponds to the location of the beacon which is detached from the mobile robot 100. When the mobile robot 100 is near and approaching the beacon 200 while maintaining a predetermined angle with the beacon 200, the touch sensing module 170 determines whether the mobile robot 100 has touched the beacon 200.

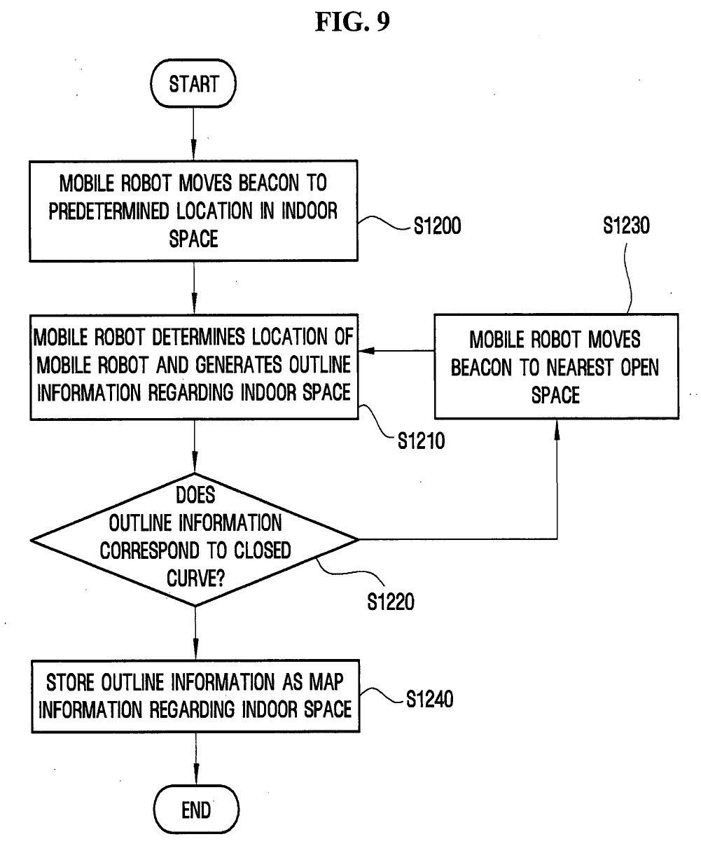

FIG. 9 is a flowchart illustrating an indoor map building method of a mobile robot 100, which involves the use of a beacon 200 that can be moved, according to an exemplary embodiment of the present invention. Referring to FIG. 9, in operation S1200, the mobile robot 100 is placed at a predetermined location in an indoor space where the mobile robot 100 is to travel, and a beacon attachment unit (not shown) of the beacon 200 detaches the beacon 200, which transmits/receives signals in order to determine its location, from the mobile robot 100 and places the beacon 200 at a predetermined location. The beacon attachment unit may comprise an electromagnet or an attachment/detachment unit having a rugged shape, but the present invention is not restricted thereto.

Thereafter, in order to determine the location of the mobile robot 100, a transmission/reception module 120 of the mobile robot 100 transmits/receives signals to/from the beacon 200 which is detached from the mobile robot 100, and provides a data processing module 110 with the signals received from the beacon 200. Then, the data processing module 110 determines the distance between the beacon 200 and the mobile robot based on the signals provided by the transmission/reception module 120 and timing information of the signals provided by the transmission/reception module 120. Examples of the signals provided by the transmission/reception module 120 include UWB signals, infrared signals, and RF signals, but the present invention is not restricted thereto.

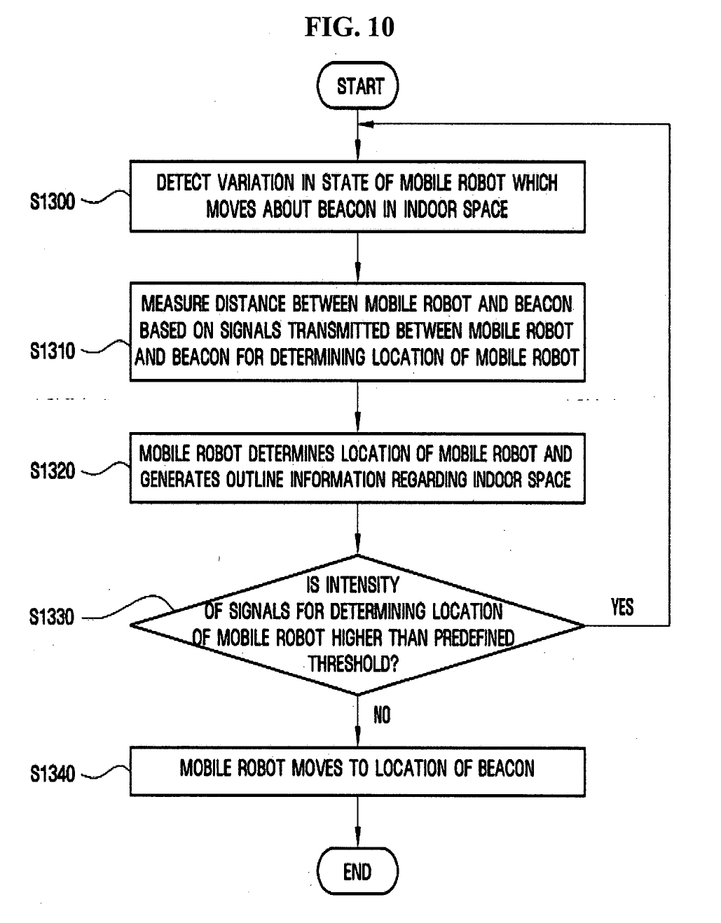

Thereafter, in operation S1210, the data processing module 110 determines the location of the mobile robot 100 based on the distance between the beacon 200 and the mobile robot 100, and an obstacle detection module 140 of the mobile robot 100 detects walls in the indoor space, and enables the mobile robot 100 to move along the detected walls, thereby generating outline information regarding the indoor space. Operation S1210 will hereinafter be described in further detail with reference to FIG. 10.

FIG. 10 is a flowchart illustrating operation S1210. Specifically, FIG. 10 illustrates the determination of the location of the mobile robot 100 and the generation of outline information regarding the indoor space. Referring to FIG. 10, in operation S1300, when the mobile robot 100 moves about the beacon 200 along walls in the indoor space when the beacon 200 is detached from the mobile robot 100, a mobile information calculator 412 detects a variation in the state of the mobile robot 100 and calculates movement information of the mobile robot 100 based on the result of the detection. In operation S1310, a distance measurer 414 transmits/receives signals that are needed for determining the location of the mobile robot 100 relative to the beacon 200 which is detached from the mobile robot 100, and measures the distance between the mobile robot 100 and the beacon 200. In operation S1320, a self-location determination unit 410 of the data processing module 110 determines a current location of the mobile robot 100, using a Kalman filter, based on the movement information provided by the encoder of the movement information calculator 412 of the self-location determination unit 410 and absolute location information obtained by the measurement performed by the distance measurer 414, the obstacle detection module 140 provides an outline generator 422 with wall detection information that is obtained by detecting the walls in the indoor space and moving along the detected walls, and the outline generator 422 generates outline information regarding the indoor space based on the wall detection information provided by the obstacle detection module 140.

As the mobile robot 100 becomes distant from the beacon 200, which is placed at a predetermined location in the indoor space, signals transmitted between the mobile robot 100 and the beacon 200 for detecting, for example, obstacles, become weaker, and thus, it becomes more difficult for the mobile robot 100 to determine the location of the mobile robot 100 and to build a map. Thus, in operation S1330, the data processing module 110 of the mobile robot 100 determines whether the amplitude of a signal transmitted between the mobile robot 100 and the beacon 200 for determining the location of the mobile robot 100 is higher than a predefined threshold. If it is determined in operation S1330 that the amplitude of the signal transmitted between the mobile robot 100 and the beacon 200 for determining the location of the mobile robot 100 is higher than the predefined threshold, the method returns to operation S1300. In operation S1340, if it is determined in operation S1330 that the amplitude of the signal transmitted between the mobile robot 100 and the beacon 200 for determining the location of the mobile robot 100 is not higher than the predefined threshold, a movement control module 150 of the mobile robot 100 controls the mobile robot 100 to move to a current location of the beacon 200, and then a beacon location fixing module 130 of the mobile robot 100 attaches the beacon 200 to the mobile robot 100.

Referring to FIG. 9, in operation S1220, a closed curve determiner 424 determines whether the outline information provided by the outline generator 422 corresponds to a closed curve. In operation S1230, if the closed curve determiner 424 determines in operation S1220 that the outline information provided by the outline generator 422 does not correspond to a closed curve, the mobile robot 100 moves to the nearest open space along with the beacon 200. In detail, in operation S1230, in order for the beacon location fixing module 130 to attach the beacon 200 to the mobile robot 100, the movement control module 150 controls the mobile robot 100 to move to the current location of the beacon 200, controls the beacon attachment/detachment unit (not shown) of the mobile robot 100 to attach the beacon 200 to the mobile robot 100, and controls the mobile robot 100 to move along with the beacon 200 to an open space that is nearest to the mobile robot 100. Thereafter, in operation S1230, the beacon location fixing module 130 places the beacon 200 at a predetermined location in the nearest open space. The mobile robot 100 may use the SLAM method to move to the nearest open space, but the present invention is not restricted to this. Once the mobile robot 100 moves to the predetermined location in the nearest open space, the beacon location fixing module 130 places the beacon 200 at the predetermined location in the nearest open space, and the method returns to operation S1210 so that the data processing module 110 determines the location of the mobile robot 100 and generate outline information by using the predetermined location where the beacon 200 currently resides as the origin.

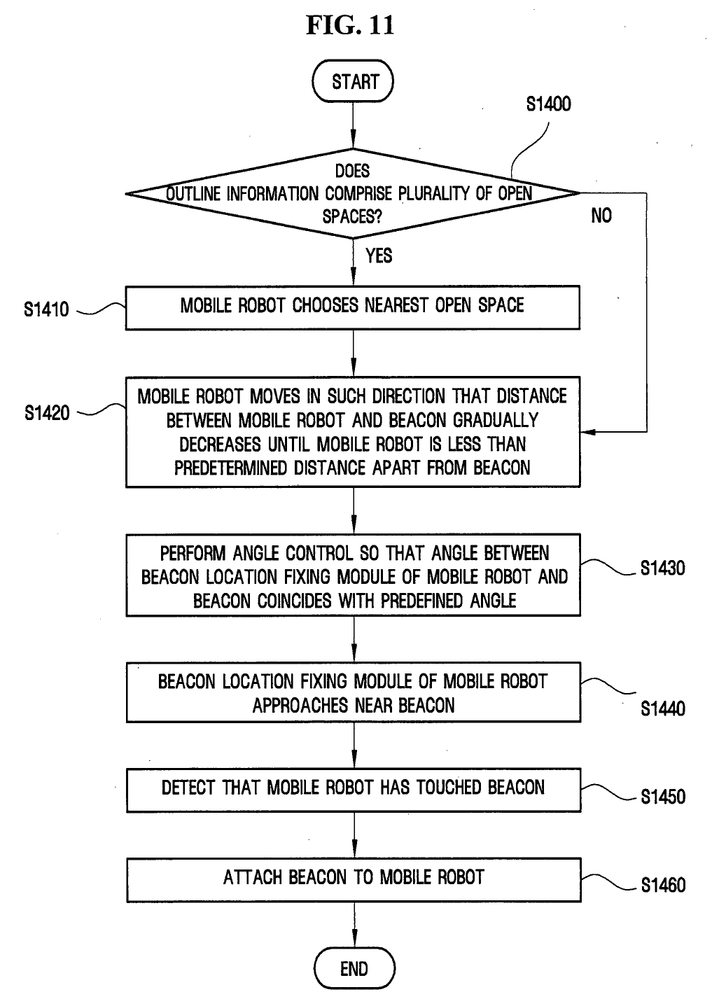

FIG. 11 is a flowchart illustrating a method of attaching a beacon 200 to a mobile robot 100 according to an exemplary embodiment of the present invention. Referring to FIG. 11, in operation S1400, an outline determiner 424 determines whether outline information provided by an outline generator 422 comprises at least one open space. In operation S1410, if the outline determiner 424 determines that the outline information comprises at least one open space, then the mobile robot 100 chooses the nearest open space. In operation S1420, the mobile robot 100 moves in such a direction that the distance between the mobile robot 100 and the beacon 200 gradually decreases, until the mobile robot 100 is less than a predetermined distance apart from the beacon 200. In operation S1430, a data processing module 110 of the mobile robot 100 controls the angle of a beacon location fixing module 130 so that both the angle of the beacon location fixing module 130 and the angle of the beacon 200 coincide with a predefined angle. In operation S1440, the beacon location fixing module 130 of the mobile robot 100 approaches the beacon 200. In operation S1450, as the mobile robot 100 is near and approaching the beacon 200, a touch sensing module 170 of the mobile robot 100 determines whether the mobile robot 100 has touched the beacon 200. In operation S1460, if the touch sensing module 170 determines that the mobile robot 100 has touched the beacon 200, a beacon attachment unit (not shown) of the beacon location fixing module 130 attaches the beacon 200 to the mobile robot 100.

Referring to FIG. 9, in operation S1240, if the closed curve determiner 424 determines in operation S1220 that the outline information provided by the outline generator 422 corresponds to a closed curve, a map information storage 426 sets an area of movement of the mobile robot 100 by the outline information provided by the outline generator 422 as map information regarding the indoor space.

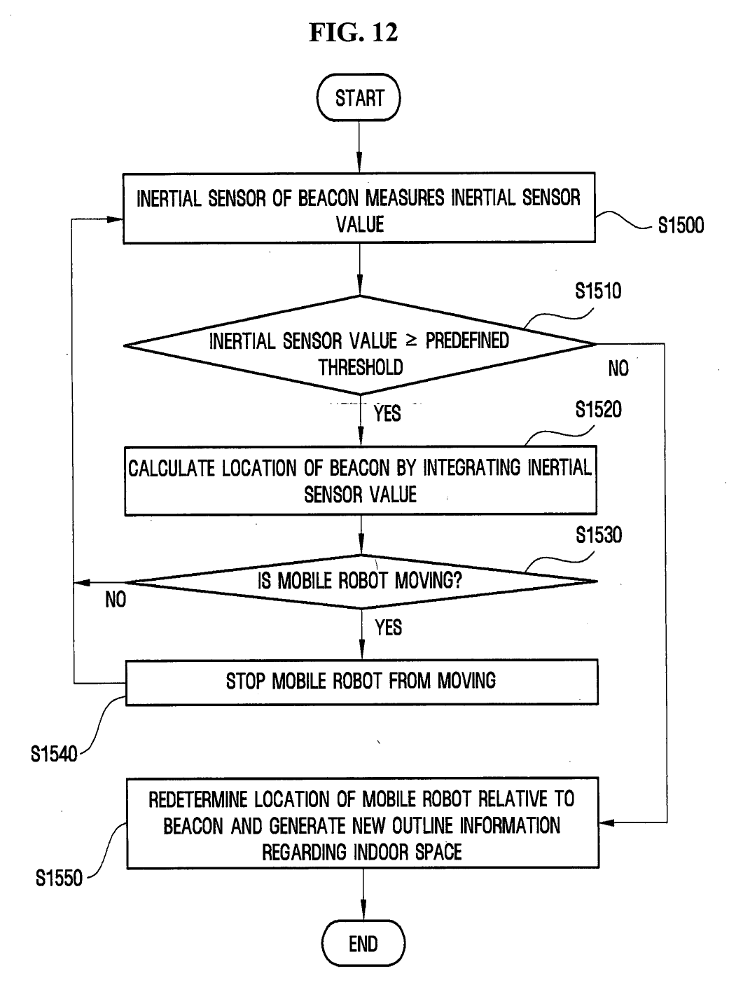

FIG. 12 is a flowchart illustrating an indoor map building method of a mobile robot 100 when the location of a beacon 200 is changed, according to an exemplary embodiment of the present invention. Referring to FIG. 12, in operation S1500, an inertial sensor 210 of the beacon 200 measures an inertial sensor value, and outputs the inertial sensor value to a data processing module 110 of the mobile robot 100. In operation S1510, the data processing module 110 determines whether the inertial sensor value is higher than a predefined threshold. In operation S1520, if it is determined in operation S1510 that the inertial sensor value is higher than the predefined threshold, then it appears that the location of the beacon 200 has been changed, and thus, the data processing module 110 calculates the location of the beacon 200 by integrating the inertial sensor value. In operation S1530, it is determined whether the mobile robot 100 is currently moving. In operation S1540, if it is determined in operation S1530 that the mobile robot 100 is currently moving, then a movement control module 150 of the mobile robot 100 is controlled to stop the mobile robot 100 from moving. A predetermined amount of time later, the inertial sensor 210 measures another inertial sensor value. Operations S1500 through S1540 are repeatedly performed until the inertial sensor 210 detects an inertial sensor value lower than the predefined threshold. If it is determined in operation S1510 that the inertial sensor value is lower than the predefined threshold, it appears that the location of the beacon 200 has not yet been changed. Thus, in operation S1550, the location of the mobile robot 100 is redetermined, and new outline information regarding an indoor space where the mobile robot 100 is to travel is generated.

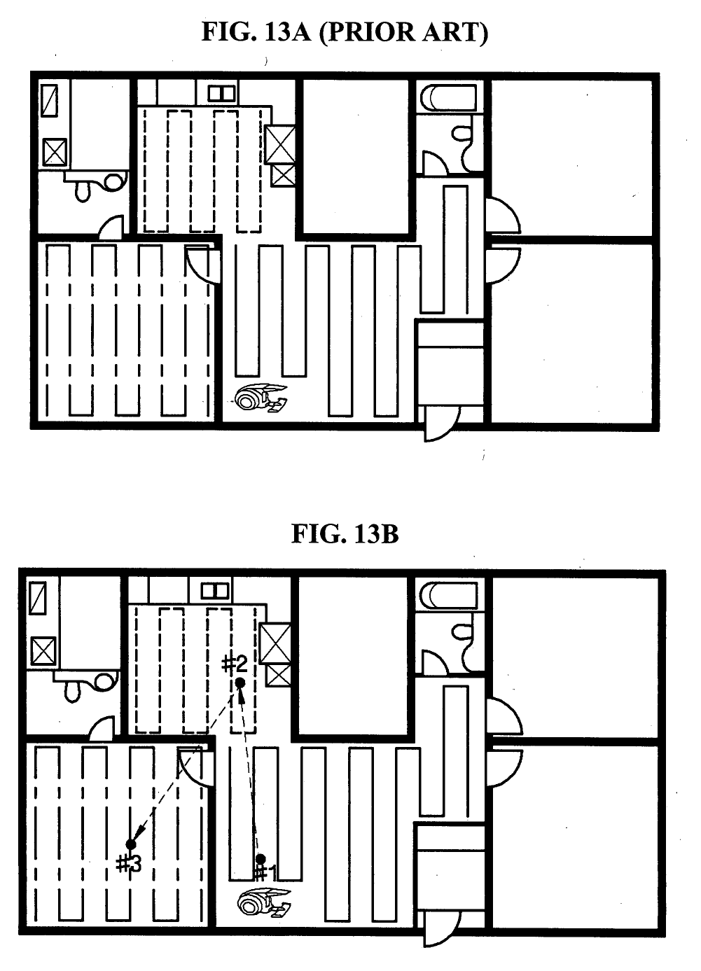

FIGS. 13A and 13B are diagrams for comparing an area of movement of a mobile robot that is set using an indoor map building method of a mobile robot according to an exemplary embodiment of the present invention with an area of movement of a mobile robot that is set using a conventional indoor map building method of a mobile robot. Assume that a mobile robot travels in a house which has a plurality of rooms that are separated from one another by walls, doors, and corridors. Referring to FIG. 13A, according to the prior art, the setting of an area of movement of a mobile robot is limited to an area indicated by solid lines, due to the characteristic of UWB signals that can hardly transmit through concrete blocks. In order to expand the area of movement of the mobile robot to cover areas indicated by dotted lines, a complicated technique such as the SLAM method is required. Referring to FIG. 13B, according to the present invention, a beacon can be attached to a mobile robot, and the mobile robot can thus move along with the beacon between spaces #1, #2, and #3 where signals can be easily obtained. Accordingly, an area of movement of the mobile robot can be set to cover all the rooms of the house by moving the beacon 200 from one room to another of the house whenever necessary. In addition, the mobile robot can perform a coverage path cleaning function according to the result of the setting, thereby leaving no spots in the house uncleaned.

According to the present invention, it is possible to set an area of movement of a mobile robot by appropriately moving a beacon that transmits/receives signals for determining the location of the mobile robot from one place to another without the need to install additional beacons or charging stands.

In addition, according to the present invention, since a mobile robot that performs its functions while traveling an indoor space comprises a beacon that can be attached to or detached from the mobile robot, the location of the mobile robot in the indoor space and map information regarding the indoor space can be precisely obtained. Thus, it is possible to set an area of movement of the mobile robot to cover the entire indoor space and to enable the mobile robot to stably operate in an actual home environment.

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter. In addition, code/instructions may include functional programs and code segments.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, DVDs, etc.), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. Examples of storage/transmission media may include wired and/or wireless transmission media. For example, storage/transmission media may include optical wires/lines, waveguides, and metallic wires/lines, etc. including a carrier wave transmitting signals specifying instructions, data structures, data files, etc. The medium/media may also be a distributed network, so that the computer readable code/instructions are stored/transferred and executed in a distributed fashion. The computer readable code/instructions may be executed by one or more processors. The computer readable code/instructions may also be executed and/or embodied in at least one application specific integrated circuit (ASIC) or Field Programmable Gate Array (FPGA).

In addition, one or more software modules or one or more hardware modules may be configured in order to perform the operations of the above-described exemplary embodiments.

The term “module”, as used herein, denotes, but is not limited to, a software component, a hardware component, a plurality of software components, a plurality of hardware components, a combination of a software component and a hardware component, a combination of a plurality of software components and a hardware component, a combination of a software component and a plurality of hardware components, or a combination of a plurality of software components and a plurality of hardware components, which performs certain tasks. A module may advantageously be configured to reside on the addressable storage medium/media and configured to execute on one or more processors. Thus, a module may include, by way of example, components, such as software components, application specific software component, object-oriented software components, class components and task components, processes, functions, operations, execution threads, attributes, procedures, subroutines, segments of program code, drivers, firmware, microcode, circuitry, data, databases, data structures, tables, arrays, and variables. The functionality provided for in the components or modules may be combined into fewer components or modules or may be further separated into additional components or modules. Further, the components or modules can operate at least one processor (e.g. central processing unit (CPU)) provided in a device. In addition, examples of a hardware components include an application specific integrated circuit (ASIC) and Field Programmable Gate Array (FPGA). As indicated above, a module can also denote a combination of a software component(s) and a hardware component(s). These hardware components may also be processors.

The computer readable code/instructions and computer readable medium/media may be those specially designed and constructed for the purposes of the present invention, or they may be of the kind well-known and available to those skilled in the art of computer hardware and/or computer software.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. An indoor map building apparatus of a mobile robot, the apparatus comprising:
a beacon which transmits/receives signals for determining the location of the mobile robot;
a beacon location fixing module which moves the beacon to a predetermined location in an indoor space where the mobile robot is to travel and fixes the beacon at the predetermined location; and
a data processing module which determines the location of the mobile robot based on signals received from the beacon, and generates map information regarding the indoor space.

2. The indoor map building apparatus of claim 1, wherein the data processing module comprises:
a movement information calculator which detects a variation in the state of the mobile robot when the mobile robot moves about the beacon in the indoor space, and calculates movement information based on the result of the detection;
a distance measurer which measures a shortest distance between the beacon and the mobile robot and generates shortest distance information based on the result of the measurement;
a location determiner which determines the location of the mobile robot based on the movement information provided by the movement information calculator and the shortest distance information provided by the distance measurer; and
a map information generator which obtains outline information regarding the indoor space based on the result of the determination performed by the location determiner, and generates map information based on the outline information.

3. The indoor map building apparatus of claim 2, wherein the map information generator comprises:
an outline generator which generates the outline information based on the results of the obstacle detection;
a closed curve determiner which determines whether the outline information corresponds to a closed curve; and
an outline information storage which stores the outline information if the closed curve determiner determines that the outline information corresponds to a closed curve.

4. The indoor map building apparatus of claim 3, wherein, if the closed curve determiner determines that the outline information comprises a plurality of open spaces, the map information generator chooses the open space that is nearest to the mobile robot.

5. The indoor map building apparatus of claim 1 further comprising:
an omnidirectional infrared transmission/reception module which measures an angle between the beacon location fixing module of the mobile robot and the beacon on a two-dimensional (2D) coordinate plane whose origin corresponds to the location of the beacon; and
a touch sensing module which determines whether the mobile robot has touched the beacon while approaching near the beacon.

6. The indoor map building apparatus of claim 5, wherein the angle between the beacon location fixing module of the mobile robot and the beacon is measured by adding angle information to infrared signals that are transmitted between the omnidirectional infrared transmission/reception module of the mobile robot and at least one omnidirectional infrared transmission/reception module of the beacon.

7. The indoor map building apparatus of claim 2, wherein the distance measurer measures the shortest distance between the beacon and the mobile robot at a location where the intensity of the signals for determining the location of the mobile robot is higher than a predefined threshold.

8. The indoor map building apparatus of claim 1, further comprising an obstacle detection module which detects an obstacle when the mobile robot travels in the indoor space.

9. An indoor map building method for a mobile robot, the method comprising:
(a) moving a beacon that transmits/receives signals for determining the location of the mobile robot to a predetermined location in an indoor space where the mobile robot is to travel;
(b) determining the location of the mobile robot based on signals received from the beacon, and generating outline information regarding the indoor space; and
(c) determining whether the outline information corresponds to a closed curve and, if it is determined that the outline information does not correspond to a closed curve, enabling the mobile robot to move the beacon to an open space that is nearest to the mobile robot and place the beacon in the open space.

10. The indoor map building method of claim 9, further comprising (d) if it is determined that the outline information corresponds to a closed curve, setting an area of movement of the mobile robot by storing the outline information as map information regarding the indoor space.

11. The indoor map building method of claim 9, wherein (b) comprises:
(b1) detecting a variation in the state of the mobile robot when the mobile robot moves about the beacon in the indoor space, and calculating movement information based on the result of the detection;
(b2) measuring a shortest distance between the beacon and the mobile robot and generates shortest distance information based on the result of the measurement;
(b3) determining the location of the mobile robot based on the movement information and the shortest distance information; and
(b4) generating the outline information regarding the indoor space based on the results of the determination performed in (b3).

12. The indoor map building method of claim 11, wherein the signals for determining the location of the mobile robot comprise ultra wide band (UWB) signals.

13. The indoor map building method of claim 9, wherein (b) comprises determining the location of the mobile robot at a location where the intensity of the signals for determining the location of the mobile robot is higher than a predefined threshold.

14. The indoor map building method of claim 13, wherein (b) is performed after moving the beacon to the location where the intensity of the signals for determining the location of the mobile robot is not higher than a predefined threshold.

15. The indoor map building method of claim 9, wherein the outline information is obtained when the mobile robot detects an obstacle and moves along the detected obstacle.

16. The indoor map building method of claim 15, wherein the mobile robot detects an obstacle using at least one of an obstacle detection sensor, a distance measurement sensor, and a bumper.

17. The indoor map building method of claim 9, wherein (c) comprises:
(c1) if the outline information comprises a plurality of open spaces, choosing the open space that is nearest to the mobile robot;
(c2) enabling the mobile robot to move in such a direction that the distance between the mobile robot and the beacon gradually decreases;
(c3) enabling the mobile robot to approach near the beacon while controlling an angle between a beacon location fixing module of the mobile robot and the beacon to coincide with a predefined angle on a 2D coordinate plane whose origin corresponds to the location of the beacon; and
(c4) determining whether the mobile robot has touched the beacon while the mobile robot approaches near the beacon and, if it is determined that the mobile robot has touched the beacon, attaching the beacon to a beacon attachment unit of the mobile robot.

18. The indoor map building method of claim 17, wherein the angle between the mobile robot and the beacon is measured by adding angle information to infrared signals that are transmitted between the mobile robot and the beacon.

19. The indoor map building method of claim 17, wherein the attachment comprises attaching the beacon to the beacon attachment unit of the mobile robot using an electromagnet.

20. The indoor map building method of claim 9, wherein, if the location of the beacon is changed during movement of the mobile robot, (b) comprises:
(b1) measuring the change in the location of the beacon using an inertial sensor of the beacon;
(b2) if an inertial sensor value obtained in (b1) is higher than the predefined threshold, stopping the mobile robot from moving, measuring a new inertial sensor value, and redetermining the location of the beacon relative to the mobile robot based on the new inertial sensor value; and
(b3) if the inertial sensor value obtained in (b1) is lower than the predefined threshold, redetermining the location of the mobile robot relative to the beacon and generating new outline information regarding the indoor space.

21. The indoor map building method of claim 10, further comprising enabling the mobile robot to perform a coverage path cleaning of a surface according to the results of the setting performed in (d).

22. The indoor map building apparatus of claim 1, further comprising a movement control module which moves the mobile robot.

23. The indoor map building apparatus of claim 22, wherein the movement control module enables the mobile robot to clean a surface area.

24. The indoor map building apparatus of claim 1, wherein the signals for determining the location of the mobile robot comprise ultra wide band (UWB) signals.

25. The indoor map building apparatus of claim 1, wherein the data processing module determines whether amplitude of at least one signal transmitted between the beacon and the mobile robot is higher than a predetermined threshold.

26. The indoor map building apparatus of claim 25, further comprising a movement control module which moves the mobile robot toward the beacon if the amplitude of the at least one transmitted signal is not higher than the predetermined threshold.

27. The indoor map building apparatus of claim 8, wherein the obstacle detection module detects an obstacle using at least one of an obstacle detection sensor, a distance measurement sensor, and a bumper.

28. The indoor map building apparatus of claim 27, wherein the beacon includes an inertial sensor.

29. At least one computer readable medium storing computer readable instructions that control at least one processor to implement the method of claim 9.

30. An indoor map building method for building a map of an indoor space using a mobile robot, the method comprising:
(a) determining the location of the mobile robot based on signals received from the beacon, and generating outline information of the indoor space; and
(b) determining whether the outline information corresponds to a closed curve and, if it is determined that the outline information does not correspond to a closed curve, enabling the mobile robot to move the beacon to an open space that is nearest to the mobile robot and place the beacon in the open space.

31. The indoor map building method of claim 30, further comprising (c) if it is determined that the outline information corresponds to a closed curve, setting an area of movement of the mobile robot by storing the outline information as map information regarding the indoor space.

32. At least one computer readable medium storing computer readable instructions that control at least one processor to implement the method of claim 30.
